(19) United States
(12) Patent Application Publication
(10) Pub. No.: US 2002/0059248 A1
(43) Pub. Date: May 16, 2002

(54) Method for determining proper color for makeup and clothing

(76) Inventor: Samuel Farchione, Nokomis, FL (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 09/910,520

(22) Filed: Jul. 20, 2001

Related U.S. Application Data
(60) Provisional application No. 60/219,765, filed on Jul. 20, 2000.

(51) Int. Cl. G06F 7/00

(52) U.S. Cl. 707/10

(57) ABSTRACT

A method for selecting fashion, including cosmetic and clothing, information for an individual. The method includes providing a fashion database that includes complimentary cosmetic information such as cosmetic product data and physical characteristic data. The step of receiving physical characteristic data for at least one individual. The step of comparing the physical characteristic data the individual with said complimentary cosmetic information to identify a selection of cosmetics that are appropriate for the individual and providing the identified information to the individual.

### RELATED APPLICATION

This application claims priority of U.S. Provisional Patent Application No. 60/219,765 filed Jul. 20, 2000, and is incorporated herein by reference.

### BACKGROUND OF THE INVENTION

1. Field of the Invention

The present invention concerns a method for determining appropriate colors of makeup and clothing for use by an individual. More specifically, the invention is directed toward a method for training sales agents in product knowledge and application as well as providing an individual with a personal analysis and review of the combinations of cosmetic colors, clothing colors, etc. that are most appropriate for that individual based upon such factors as skin color, hair color, eye color, body shape and body proportion.

2. Reference to Related Art

The problems confronting the cosmetic and clothing industry are twofold. A first problem is that sale agents/employees of these companies must, prior to entering the sales force, undergo a lengthy training period to gain knowledge regarding the products they are selling and learn proper techniques for using and/or applying those products. For example, a cosmetic sales agent must learn not only the names and characteristics of the products that he or she is selling, they must also understand how to apply those products and be able to recognize what products are appropriate for each new client based upon that client's physical characteristics (hair color, eye color, skin color and tone, body shape, etc.). Acquiring and understanding this knowledge can take weeks or, in some cases, months. During this time, the agent must be paid a salary. However, until the sales agent completes his or her training and joins the sales force the company will lose money with respect to that agent. Therefore, it would be beneficial to have a system that decreases the time necessary for a sales agent to gain adequate product knowledge and skill.

A second industry problem is that a client often has no idea regarding which color, style or product of cosmetic, clothing, shoe, etc., is most appropriate for them based upon their own physical characteristics. Therefore, it would be advantageous to have a system that provides that information to the client.

### BRIEF SUMMARY OF THE INVENTION

The present invention is directed to a method for providing fashion information for an individual customer. The invention includes a first step of providing a style database having complimentary fashion. The complimentary fashion information includes cosmetic product data (e.g., information concerning lines of cosmetics, brands, styles, colors, textures, medicinal qualities and chemical qualities) and physical characteristic data (e.g., skin color, skin tone, hair color, eye color, body shape, shape of the face, body proportions). Alternatively, or additionally, the complimentary fashion information may include clothing information such as clothing sizes, styles, fabric colors and textures and footwear data. Significantly, the style database may be utilized as a stand alone training or sales platform or, as described below, be combined with a second database.

In a next step there is provided a personal characteristic database that is adapted to receive physical characteristic data, as described above, for at least one individual.

In a third step, there is provided at least one input device, such as a digital camera, colorimeter, spectrophotometer or retinal scanner that records physical characteristic data for an individual and communicates that data to the personal characteristic database. Physical characteristic data may also be input into the personal characteristic database via a personal computer.

In a next step, the individual's physical characteristic data is electronically compared, using e.g., a CPU, with the complimentary fashion information contained in the style database to identify a selection of cosmetics and/or clothes that are appropriate, preferably complimentary, to the individual based upon that individual's physical characteristics or their desired fashion outlook.

In a final step, the individual is provided with the information identified by the comparison. Preferably, this information is provided as a booklet or computer printout.

The present invention may be adapted such that it may be utilized as a teaching aid for new employees. Alternatively, physical characteristic data for one or many individuals is electronically stored and made accessible via a computer network such as the Internet. This stored data is thus transmittable to on-line and traditional clothing and cosmetic retailers for use in purchasing goods and services.

### BRIEF DESCRIPTION OF THE DRAWINGS

These and other features, aspects and advantages of the present invention will become better understood with regard to the following description, claims and accompanying drawings wherein:

FIG. 1 is a diagram of a preferred embodiment of the the method of the present invention;

FIG. 2 is a flowchart of an alternative embodiment of the method of the present invention;

FIG. 3 is a diagram of an alternative embodiment of the present invention;

### DETAILED DESCRIPTION OF THE INVENTION

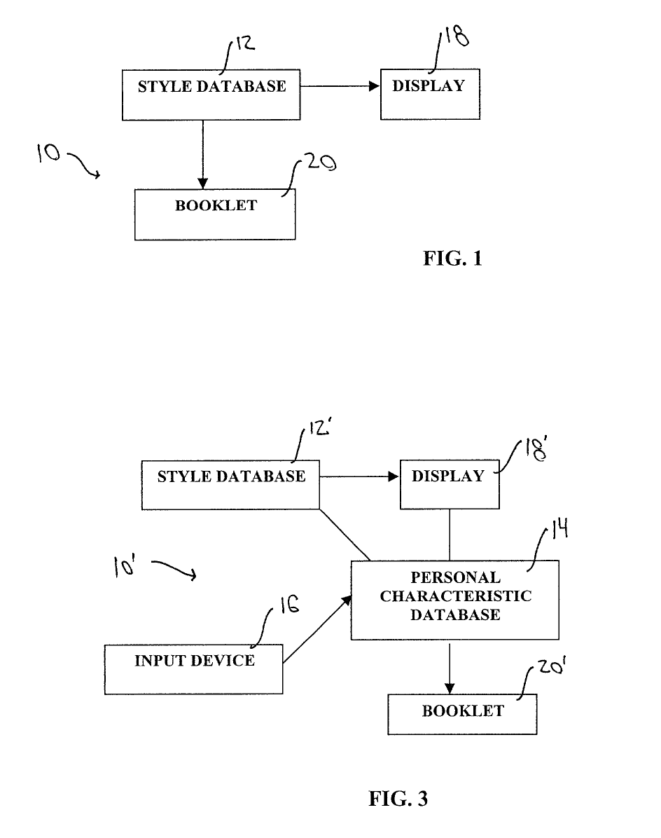

Referring now to FIGS. 1 and 3, the method 10 of the present invention preferably includes a first style database 12 usable for training cosmetic and clothing sales agents. In an alternative embodiment the method also includes a second personal characteristic database 14 useable for storing information concerning an individual's physical characteristics; and at least one input device 16 for measuring or otherwise inputting those physical characteristics into the personal characteristic database 14.

To teach and train a person employed in the cosmetic or clothing industry a style database 12 (preferably a multi-media presentation database) is provided that includes instructional information regarding makeup application techniques. Specifically, the style database 12 contains systematic instructions, as well as video and/or pictures that teach proper methods for applying various cosmetics or combinations of cosmetics in order to receive a particular result.

Preferably the style database 12 also includes complimentary fashion information such as instructions regarding the color of lipstick that is most appropriate for a potential client based upon that client's physical characteristics (hair color, eye color, body shape, etc.) as well as a video segment or a series of pictures that detail how the product is applied (or combined with other products) in order to achieve a desirous result for the client (i.e., fuller lips, pouty lips, etc.). Complimentary fashion information contained in the style database 12 also preferably includes categories of data such as: cosmetic data (e.g., brand information, cosmetic style, colors, textures, medicinal qualities or chemical qualities); product types (lipstick, eye liner, bases, etc.); physical characteristic data (e.g., skin colors, hair colors, eye colors, facial shapes, body proportions, body measurements) and requested results (e.g., highlight eyes, full lips, highlight cheekbones).

Ideally, the sales agent may select and combine categories of data within the style database 12 in order to receive a multimedia presentation (broadcast via a display 18 such as a television or computer monitor) regarding appropriate techniques to use in a particular situation. For example, the sales agent may combine the information within the physical characteristics category of 1. pale skin, 2. dark hair, 3. brown eyes, 4. narrow face, 5. thin build, in connection with a requested result category for “highlighted eyes” and receive instructional information concerning which colors, or more specifically, which product or brand, works best to highlight the client's eyes. Accordingly, the method of the present invention has the advantage of decreasing the amount of time necessary to train an employee in the appropriate techniques of color analysis as well as the application of cosmetic products.

This method may be adapted for use by the sales agent after he or she has completed training. For example, upon entering a traditional brick and mortar cosmetic or clothing store, a client may request a particular product or make an inquiry concerning what products are useful for achieving a particular result (e.g., highlight cheekbones, appear thinner, appear bigger, etc.). The sales agent may access the style database 12 in order to assist the client in determining which products and colors work best that the client and will provide the requested result. The client may also be provided with a printout such as a booklet 20 that identifies appropriate cosmetic products and provides instructions concerning the proper application of that product.

This method may also be adapted for use with the clothing industry. However, rather than providing cosmetic product information, the agent is provided with complimentary fashion information that includes clothing colors, fabrics, and styles, including footwear data, that are most appropriate given a potential client's physical characteristics.

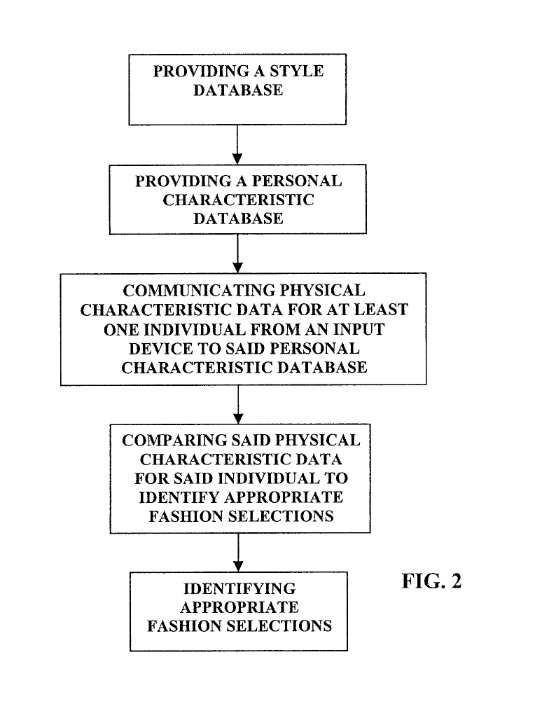

Referring now to FIGS. 2 and 3, in an alternative embodiment 10′ of the present invention, the individual is provided with a personal analysis and review of the combinations of cosmetics and/or clothing that are most appropriate for that individual based upon such physical characteristics such as skin color, hair color, eye color, body shape and body proportion. In this alternative there is provided a personal characteristic database 14 as well as an input device 16 for recording a client's physical characteristics. Preferably, physical characteristic data for at least one individual is input into the personal characteristic database 14 via the input device 16. As will be discussed further below, the personal characteristic database 14 is centrally located and accessible by the client or a retailer over a computer network, such as the Internet, by use of a PIN.

In this further embodiment, the client undergoes a complete analysis of their physical characteristics. For example, upon entering the store and after preferably paying a fee, images of the client, as well as various body measurements, dimensions and descriptions (e.g., skin color, skin tone, pores, face dimensions (narrow or wide), feet size and dimensions, hair color, eye color, etc.) are input into the personal characteristic database 14. Preferably, this information is uploaded directly from the input device 16, such as those discussed below that adapted to directly measure and/or scan the client's physical features. Alternatively, the sales agent may manually record and input the appropriate data into the personal characteristic database 14 via, e.g., a personal computer.

The client's recorded physical characteristics are then preferably electronically compared using, e.g., a CPU, with the complimentary fashion information of the style database 12′ to identify a selection of cosmetics, clothing, etc. that is appropriate for that individual based upon that individual's physical characteristics. Notably, any information input or output from the system is viewable via a display 18′.

The client is next provided with a printout or booklet 20′ that identifies appropriate recommendations regarding complementary colors, cosmetic products, clothing, etc., for that client's physical characteristics. The booklet 20′ may also include before and computer generated after pictures of the client as well as instructional information detailing how to use and apply new cosmetics.

Additionally, the system of the present invention may provide measurement information that the client may use in the design of custom tailored clothing, including footwear. Indeed, as a further alternative embodiment, the customer may utilize his or her personal information (measurements, appropriate colors, appropriate styles) to order custom tailored clothing. Preferably, the client will place an order with a clothing tailor via an electronic computer network (i.e., the Internet). Alternatively, the client may phone, mail or otherwise communicate their order to the tailor and concurrently provide the tailor with the necessary information to access the client's information on the personal characteristic database 14, which as previous stated is accessible via a computer network. This method has the advantage of allowing the client to order custom tailored clothing from anywhere in the world.

The method of the present invention may also be adapted to provide appropriate color information for use by the client during each of the four seasons and provide that client with information concerning the actual application of the make-up.

Input devices 16 for use with the present invention will now be discussed. A preferred method for scanning and analyzing a client's skin color is shown in U.S. Pat. No. 5,835,625 (incorporated herein by reference) that issued Nov. 10, 1998 to Fitzpatrick and is assigned to I.B.M., Inc. Upon scanning an image, the technology of the '625 patent assigns a hypothetical identity to the unknown character if the determined proportion falls within a preselected range of a preselected proportion for a known character corresponding to the hypothetical identity. Therefore, the '625 patent has application in analyzing a wide range of skin color and textures.

A calorimeter or, alternatively a spectrophotometer such as those manufactured by Datacolor International, Inc., of Lawrenceville, N.J. may be utilized to scan and analyze skin coloration.

As a further alternative, a digital camera (such as a Kodak DC 290, Polaroid PDC 700 or the Magcon Coolpix 950) is used to capture an image of the client's skin. Use of a digital camera also allows the operator to picture the client under various lighting conditions and allows for multiple subsequent operations (such as determination of skin color, facial shape and eye shape and color). As a still further alternative, a hand-held scanner (such as a View Scan Home I by Artec) may be utilized to capture an image of the client's skin.

The method of the present invention may also be utilized to determine appropriate colors for use in clothing (including footwear), and may take into account eye color and shape. Preferably, an image of the client's eyes may be obtained using a retinal scanner incorporating, for example, the technology of the EyeDentify ICAM 2001 manufactured by Rayco Security of Van Nuys, Calif. Alternatively, a digital camera may again be used to capture an image of the client's eyes and body.

In summary, once the client's data is uploaded into the personal characteristic database 14 and verified for accuracy, the data is compared to determine appropriate personal colors of cosmetics, clothing, etc. Preferably, the client's physical characteristics (skin color, eye shape or color, body shape, etc.) are compared with the style database 12 to identify appropriate cosmetics and clothing choices for that client. Notably, the system of the present invention may be adapted to automatically identify any skin imperfections or those imperfections may be indicated manually in the system. Alternatively, PhotoShop or a similar software package may be utilized or modified to provide information regarding appropriate complementary colors.

Following input and comparison of a client's physical characteristics, the client is provided with a printout or booklet 20′ that includes a description of all their physical characteristics and recommended appropriate complementary fashions of cosmetics, clothing, etc, based upon those characteristics.

All information regarding a client's physical characteristics (i.e., skin and eye color and shape, face and body shape) is recorded into a personal characteristic database 14. In the event a client desires to order clothing, makeup, etc., either in a traditional retail store or on-line, the client, or alternatively the store, may access the database to obtain the client's information. Access to the database is preferably controlled by means of a PIN and it is contemplated that a fee may be charged for this service. Furthermore, once the client's physical characteristic information is stored in the second database, that information may be automatically updated to provide the client with new information for each season.

Having thus described my invention, other embodiments will be apparent to those having skill in the art that do not depart from the scope of the present invention.

I claim:

1. A method for selecting fashion information for an individual, said method comprising the steps of:
providing a style database including complimentary fashion information having cosmetic data and physical characteristic data;
providing a personal characteristic database being adapted to receive physical characteristic data for at least one individual;
communicating physical characteristic data for at least one individual from an input device to said personal characteristic database;
comparing said physical characteristic data for said at least one individual with said style database to identify a selection of cosmetics that are appropriate for said individual based upon said individual's physical characteristics; and
identifying for said individual cosmetics that are appropriate for the individual based upon the individual's physical characteristics.

2. The method of claim 1, wherein said style database further comprises instructional data concerning the proper application of cosmetics.

3. The method of claim 2, wherein said instructional data comprises a multimedia presentation.

4. The method of claim 2, wherein said multimedia presentation comprises a video presentation.

5. The method of claim 1, wherein said cosmetic data comprises at least one cosmetic characteristic selected from a group consisting of: cosmetic brand, cosmetic style, colors, textures, medicinal qualities or chemical qualities.

6. The method of claim 1, wherein said physical characteristic data comprises at least one physical characteristic selected from a group consisting of: skin color, skin tone, hair color, eye color, facial shape, body proportions, body measurements.

7. The method of claim 1, wherein said input device comprises a digital camera.

8. The method of claim 1, wherein said input device comprises and colorimeter.

9. The method of claim 1, wherein said input device comprises spectrophotometer.

10. The method of claim 1, wherein said input device comprises a computer.

11. The method of claim 1, wherein said style database further comprises footwear information.

12. The method of claim 1, wherein said style database further comprises clothing information.

13. The method of claim 12, wherein said clothing information includes at least one clothing data selected from a group consisting of: size data, style data, fabric color data and fabric texture data.

14. The method of claim 1, wherein said personal characteristic databases is accessible via a computer network.

15. A method for selecting fashion information for an individual, said method comprising the steps of:
providing a style database including complimentary fashion information, said complimentary cosmetic information having cosmetic product data and physical characteristic data;
receiving physical characteristic data for at least one individual;
comparing said physical characteristic data for said at least one individual with said complimentary fashion information to identify a selection of cosmetics that are appropriate for said individual based upon said individual's physical characteristics; and
identifying for said individual cosmetics that are appropriate for the individual based upon the individual's physical characteristics.

16. A method for providing fashion information for an individual, said method comprising the steps of:
providing a style database having complimentary fashion information;
providing a personal characteristic database being adapted to receive physical characteristic data for at least one individual;
communicating physical characteristic data for at least one individual from an input device to said personal characteristic database;
comparing said physical characteristic data for said at least one individual with said style database to identify appropriate cosmetic or clothing selections for said individual based upon said individual's physical characteristics; and
identifying for said individual cosmetics or clothing selection that are appropriate for the individual based upon the individual's physical characteristics.
